(19) United States
(12) Patent Application Publication
(10) Pub. No.: US 2002/0183442 A1
(43) Pub. Date: Dec. 5, 2002

(54) New polyurethanes and their use for the thickening of aqueous systems

(76) Inventors: Christian Wamprecht, Neuss (DE); Jan Mazanek, Koln (DE); Peter Manshausen, Koln (DE); Frank Sauer, Langenfeld (DE)

Correspondence Address: BAYER CORPORATION, PATENT DEPARTMENT, 100 BAYER ROAD, PITTSBURGH, PA, 15205, US

(21) Appl. No.: 10/092,212

(22) Filed: Mar. 6, 2002

(30) Foreign Application Priority Data
Mar. 12, 2001 (DE) 10111792.2

(51) Int. Cl. C08J 3/00

(52) U.S. Cl. 524/589

(57) ABSTRACT

The invention relates to a new hydrophilic/water-soluble or water-dispersible polyurethane comprising the reaction product of

A) at least one polyether polyol a1) having a average functionality of ≧3 and at least one urethane group-containing polyether polyol a2) having an average functionality of ≧4,

B) at least one monoalcohol with 6 to 22 carbon atoms,

C) at least one (cyclo)aliphatic and/or aromatic diisocyanate

D) optionally at least one monoisocyanate with 4 to 18 carbon atoms, and

E) optionally at least one polyisocyanate having a average functionality of >2,

wherein the starting NCO/OH equivalent ratio is between 0.5:1 to 1.2:1, and which is suitable as thickening agents for aqueous systems, with a particularly efficient thickening effect in the high-shear range.

### BACKGROUND OF THE INVENTION

The present invention relates to a hydrophilic/hydrophobic water-soluble or water-dispersible polyurethanes suitable as thickening agent for aqueous systems, having a particularly efficient thickening effect in the high-shear range, as well as its use for the thickening of aqueous systems.

Polyurethane-based thickening agents for aqueous systems are described in numerous publications, (see for example DE-A 1 444 243, DE-A 3 630 319, EP-A-0 031 777, EP-A-0 307 775, EP-A-0 495 373, U.S. Pat. Nos. 4,079,028, 4,155,892, 4,499,233 or 5,023,309).

A common feature of these thickening agents belonging to the prior art is the simultaneous presence of (i) hydrophilic segments in an amount of at least 50 wt. %, (ii) hydrophobic segments in an amount of at most 10 wt. % and (iii) urethane groups. The term “hydrophilic segments” is understood to mean in particular polyurethane chains with at least 5 chain members whose alkylene oxide units contain at least 60 mole % of ethylene oxide units. The term “hydrophobic segments” is understood to mean in particular hydrocarbons segments with at least 6 carbon atoms that are incorporated within the chain and/or are preferably incorporated in the terminal position.

The thickening agents according to the invention described hereinafter also preferably correspond to this definition.

These polyurethane thickening agents are suitable as auxiliary substances for adjusting the rheological properties of aqueous systems, such as automotive and industrial paints, plaster paints and coating compounds, printing inks and textile dyes, pigment printing pastes, pharmaceutical and cosmetic preparations, plant protection formulations or filler dispersions.

Although the known polyurethane thickeners have a wide application, they are nevertheless insufficiently effective for some areas of application. A particular problem in the use of polyurethane thickeners is that they must exhibit a good effect not only in the range of low shear rates (which is important in particular for the settling behaviour and flow of for example paints), but also at high shear rates (high-shear range) that occur when applying the preparations using for example brushes or rollers, or also by spraying. For these reasons in the prior art two basic types of thickeners for the respective range of the shear rates are generally used in a preparation, or further auxiliary substances are added, such as solvents, in order to reduce the low-shear viscosity. This often employed measure leads however to an increase in volatile and/or migration-capable fractions in the paint formulation, which is undesirable in particular for environmental protection reasons.

In the past many attempts have been made in order to improve the effectiveness of aqueous polyurethane thickeners, such as by the incorporation of hydrophobic segments in the polymer chain of the thickener or by the use of hydrophobic side chains. The increasing demands in the market have led however over the last few years to the need for even further improved products. By using thickening agents that are improved compared to the prior art either paints with improved coating properties would be obtained using the same application amount, or alternatively the same coating properties could be achieved by using a lower application amount, which would also lead to economic advantages compared to the old systems.

It is an object of the invention to provide new polyurethane-based thickening agents for aqueous or mainly aqueous systems that have an improved effectiveness in the high-shear range.

This object was achieved by the hydrophilic/hydrophobic water-soluble or water-dispersible polyurethanes according to the invention which are described in more detail hereinafter. The essential feature of the invention is the specific incorporation of selected hydrophilic and/or hydrophobic segments by using special alcohols and/or special alcohol mixtures, as well as the use of special polyethers as reaction partners for the isocyanate component.

### SUMMARY OF THE INVENTION

The invention relates to a water-soluble or water-dispersible polyurethane containing a reaction product of

A) at least one polyether polyol a1) having an average functionality of ≧3 and at least one urethane group-containing polyether polyol a2) having an averagefunctionality of ≧4,

B) at least one monoalcohol with 6 to 22 carbon atoms,

C) at least one (cyclo)aliphatic and/or aromatic diisocyanate

D) optionally at least one monoisocyanate with 4 to 18 carbon atoms, and

E) optionally at least one polyisocyanate having an average functionality of >2,

wherein the starting NCO/OH equivalent ratio is between 0.5:1 to 1.2:1.

The present invention also relates to a process for the production of this water-soluble or water-dispersible polyurethane by reacting

A) a mixture of at least one polyether polyol a1) having an average functionality of ≧3 and at least 1 urethane group-containing polyether polyol a2) having an average functionality of ≧4,

B) at least one monoalcohol with 6 to 22 carbon atoms,

C) at least one (cyclo)aliphatic and/or aromatic diisocyanate,

D) optionally at least one monoisocyanate with 4 to 18 carbon atoms, and

E) optionally at least one polyisocyanate having an average functionality of >2

at a starting NCO/OH equivalent ratio of 0.5:1 to 1.2:1.

The invention also relates to a process for adjusting the flow properties of an aqueous paint system, adhesive and another aqueous formulation by adding this polyurethane to the aqueous paint system, adhesive and another aqueous formulation.

### DETAILED DESCRIPTION OF THE INVENTION

Polyether polyol component A) contains a mixture of a polyether polyol a1) of formula (I)

R₁[—O—(A)ₓ—H]_{y} (I),

wherein

R₁ represents an aliphatic or araliphatic hydrocarbon radical with 4 to 36 carbon atoms and optionally having ether oxygen atoms,

A represents ethylene oxide and/or propylene oxide radicals with the proviso that at least 50 mole %, preferably 70 mole % and particularly preferably 100 mole % of the radicals represent ethylene oxide radicals,

x represents a number from 30 to 250, and

y represents a number from 3 to 18, preferably 3 to 6,

and a urethane group-containing polyether polyol a2) of formula (II)

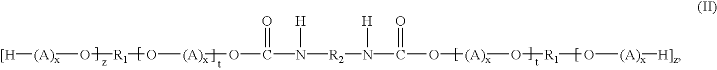

wherein

R₁ represents an aliphatic or araliphatic hydrocarbon radical with 4 to 36 carbon atoms optionally containing ether oxygen atoms,

R₂ represents an aliphatic, araliphatic, cycloaliphatic or aromatic radical with 4 to 12 carbon atoms,

A represents ethylene oxide and/or propylene oxide radicals with the proviso that at least 50 mole %, preferably at least 70 mole % and particularly preferably 100 mole % of the radicals represent ethylene oxide radicals,

x represents a number from 30 to 250,

y represents a number from 3 to 18, preferably 3 to 6, and

z represents a number from 2 to 16, preferably 2 or 4, and t=(y−z).

Monoalcohol component B) contains at least one monohydric alcohol of formula (III)

R₃—OH (III),

wherein

R₃ represents an aliphatic, cycloaliphatic, aromatic or araliphatic hydrocarbon radical with 6 to 22, preferably 6 to 18, more preferably 8 to 14 carbon atoms and optionally having inert substituents, e.g. halogen.

Component C) contains at least one diisocyanate of formula (IV)

OCN—R₄—NCO (IV),

wherein

R₄ represents an aliphatic, araliphatic, cycloaliphatic or aromatic radical with 4 to 22 carbon atoms and optionally containing inert substituents, e.g. halogen.

It is understood by the skilled artisan that the groups R₃ and R₄ can optionally contain substituents that preferably are inert to the isocyanate group or the hydroxy group of the respective reaction partner.

Component D) optionally contains at least one monoisocyanate of formula (V)

R₃—NCO (V),

wherein

R₃ has the meaning given in formula (III).

Component E) contains at least one aliphatic, araliphatic, cycloaliphatic, heterocyclic or aromatic polyisocyanate with a functionality of >2.

The production of polyether a1) on which the mixture of polyether alcohols A) is based is carried out in a manner known per se by alkoxylation of corresponding polyhydric alcohols of the formula (VI)

R₁—[OH]_{y} (VI),

wherein

R₁ and y have the meaning given for formula (I),

using ethylene oxide and optionally propylene oxide in a mixture and/or arbitrary sequence. Suitable initiators include glycerol, trimethylolpropane, trimethylolethane, pentaerythritol, di-trimethylolpropane, sorbitol, sugars, etc. Glycerol, trimethylolpropane and sorbitol are preferably used, and glycerol and sorbitol are more preferably used.

The production of polyether alcohol mixture A) containing polyethers a1) and urethane group-containing polyethers a2) is carried out by the partial reaction of polyethers a1) with at least one organic isocyanate having a functionality of ≧2. In this context up to 50 mole %, preferably up to 20 mole % and more preferably up to 10 mole % of polyethers a1) may be reacted with isocyanates. The reaction is carried out in a temperature range from 0° to 180° C., preferably 20° to 160° C. and more preferably 60° to 120° C.

Examples of monoalcohol components B) include aliphatic alcohols such as 1-butanol, 1-pentanol, 1-hexanol, 1-heptanol, 1-octanol, 2-ethylhexanol, 1-nonanol, 1-decanol, 1-dodecanol, stearyl alcohol, etc. Monoalcohols with 6 to 16 carbon atoms are preferred, monoalcohols with 8 to 14 carbon atoms being more preferred.

Examples of diisocyanates of component C) include aliphatic diisocyanates such as 1,4-butane diisocyanate or 1,6-hexane diisocyanate; cycloaliphatic diisocyanates such as 1-isocyanato-3,3,5-trimethyl-5-isocyanatomethyl-cyclohexane (isophorone diisocyanate), 1,3- and 1,4-cyclohexane diisocyanate, 4,4′-diisocyanatodicyclohexylmethane, and others, as well as aromatic diisocyanates such as 2,4-diisocyanatotoluene and 4,4′-diisocyanatodiphenylmethane.

Examples of monoisocyanate component D) include aliphatic monoisocyanates such as 1-butyl isocyanate, 1-pentyl isocyanate, 1-hexyl isocyanate, 1-heptyl isocyanate, 1-octyl isocyanate, 1-nonyl isocyanate, 1-decyl isocyanate, 1-dodecyl isocyanate, stearyl isocyanate, etc. Preferred are isocyanates with 8 to 18 carbon atoms, monoisocyanates with 10 to 18 carbon atoms being more preferred.

Examples of polyisocyanate component E) include commercially available lacquer polyisocyanates, in other words in particular the known modification products of simple diisocyanates containing urethane groups, uretdione groups, allophanate groups and in particular biuret groups, isocyanurate groups and iminooxadiazine-dione groups, examples of suitable diisocyanates include 1,6-diisocyanatohexane, 1-isocyanato-3,3,5-trimethyl-5-isocyanatomethylcyclohexane (isophorone diisocyanate), 4,4′-diisocyanatodicyclohexylmethane, 1,4-diisocyanatocyclohexane, 1-methyl -2,4-diisocyanatocyclohexane and its mixtures with up to 35 wt. %, based on the total mixture, of 1-methyl-2,6-diisocyanatocyclohexane; 2,4-diisocyanato-toluene and its mixtures with up to 35 wt. %, referred to the total mixture of 2,6-diisocyanototoluene or its mixtures. More preferably used are the corresponding lacquer polyisocyanates with aliphatically and/or cycloaliphatically bound, free isocyanate groups. A suitable polyisocyanate that does not contain the aforementioned groupings is 4-isocyanatomethyl-1,8-octane diisocyanate.

Laquer polyisocyanates containing urethane groups include for example the reaction products of 2,4- and optionally 2,6-diisocyanatotoluene or 1-methyl-2,4-diisocyanatocyclohexane and optionally 1-methyl-2,6-diisocyanatocyclohexane with sub-stoichiometric amounts of trimethylolpropane, or their mixtures with simple diols such as the isomeric propanediols or butanediols. The production of such urethane group-containing laquer polyisocyanates in practically monomer-free form is described for example in DE-A 1 090 196.

The biuret group-containing laquer polyisocyanates that are more preferred for use according to the invention include in particular those based on 1,6-diisocyanatohexane and are described for example in EP-A 0 003 505, DE-A 1 101 394, U.S. Pat. No. 3,358,010 or U.S. Pat. No. 3,903,127.

The more preferred isocyanurate group-containing laquer polyisocyanates include also in particular the trimers or mixed trimers of the diisocyanates mentioned above, such as the isocyanurate group-containing polyisocyanurates based on diisocyanatotoluene described in GB-A 1 060 430, GB-A 1 506 373 or GB-A 1 485 564, the mixed trimers of diisocyanatotoluene with 1,6-diisocyanatohexane, which may be obtained for example according to DE-A 1 644 809 or DE-A 3 144 672, and in particular the aliphatic, aliphatic-cycloaliphatic and cycloaliphatic trimers or mixed trimers based on 1,6-diisocyanatohexane and/or isophorone diisocyanate, which may be obtained for example according to U.S. Pat. No. 4,324,879, U.S. Pat. No. 4,288,586, DE-A 3 100 262, DE-A 3 100 263, DE-A 3 033 860 or DE-A 3 144 672. The laquer polyisocyanates that may be used according to the invention generally have an isocyanate content of 5 to 25 wt. %, a average NCO functionality of 2.1 to 5.0, preferably 2.8 to 4.0, and a residual content of starting monomeric diisocyanates of less than 2 wt. %, preferably less than 0.5 wt. %. Mixtures of the laquer polyisocyanates may also be used.

The production of the polyurethanes according to the invention is carried out in one or several stages. A one-stage reaction in this context means for example the reaction of the total amount of component a1) with the total amount of components B), C), optionally D) and optionally E). Component A) is then formed in situ depending on the chosen amount of component C). A multi-stage reaction means for example reacting part of the component a1) with part of component C), followed by reacting resultant component A) with component B), the remainder of component C), as well as optionally components D) and E). A multi-stage reaction can also or additionally contain a separate reaction of part of or the total amount of monoalcohol components B) with a molar excess of diisocyanate components C) followed by reaction of the resulting NCO prepolymer with the previously produced component A) and optionally components D) and E). The sequence of the reactions is in this case not particularly important, and it only has to be ensured that component A) according to the above definition can be formed by suitably choosing the amounts to be used of components A) to C) and optionally D) and E).

The polyurethanes according to the invention are generally colorless to yellowish waxes or highly viscous polymers having softening points or softening ranges within the temperature range from 10° to 80° C. For subsequent use it is often advantageous to mix the polyurethanes according to the invention with additives, such as formulation agents, solvents, water, emulsifiers or stabilizers, to form liquid formulations.

The polyurethanes according to the invention are suitable for thickening aqueous or predominantly aqueous systems. Example include applications in the field of colorants, leather treatment and paper auxiliary substances, preparations for petroleum extraction, detergent and adhesive preparations, waxes for polishes, formulations for pharmaceutical and veterinary purposes, plant protection preparations, cosmetics articles, etc. Also water itself can be thickened with the polyurethane thickeners according to the invention so that optionally further additives can be added or alternatively the water itself can be added to aqueous preparations. The thickeners according to the invention may also be used in mixtures with other thickening agents, such as those based on polyacrylates, cellulose derivatives or inorganic thickening agents.

Examples of aqueous systems that can be thickened according to the invention also include aqueous polyacrylate dispersions, aqueous dispersions of copolymers of olefinically unsaturated monomers, aqueous polyvinyl acetate dispersions, aqueous polyurethane dispersions, aqueous polyesters dispersions and in particular ready-for-use preparations of the type already described above based on such dispersions or mixtures of such dispersions.

In one embodiment the thickening agents according to the invention may used in bulk, preferably as granules or optionally powders. It is preferred however to use liquid formulations that can contain, in addition to the polyurethanes according to the invention, also water, solvents such as butyl diglycol, isopropanol, methoxypropyl acetate, ethylene glycol and/or propylene glycol, non-ionic emulsifiers, surfactants and/or optionally further additives since in this way the incorporation of the thickening agents according to the invention into aqueous or predominantly aqueous systems is substantially facilitated.

The ready-for-use preparations of the thickening agents according to the invention are particularly preferably aqueous solutions or dispersions having a solids content of 10 to 80, preferably 30 to 60 and particularly preferably 40 to 50 wt. %.

The amount of thickening agents according to the invention that is added to the aqueous or predominantly aqueous systems in order to achieve the desired thickening effect depends on the intended use and may be determined by the person skilled in the art in a few preliminary experiments. As a rule 0.05 to 10 wt. %, preferably 0.1 to 4 wt. % and particularly preferably 0.1 to 2 wt. % of the thickening agent according to the invention is used, these percentage figures referring to the solids content of the thickening agent on the one hand and to the solids content of the aqueous system to be thickened on the other hand.

The evaluation of the effectiveness of the thickening agents according to the invention may be carried out by known methods, for example in a Haake rotary viscosimeter, in a Stormer or Brookfield viscosimeter, or in an ICI viscosimeter.

### EXAMPLES

Raw Materials Used

Polyether a₁):

| | |
|---|---|
| I | Polyether based on glycerol and a mixture of ethylene oxide and |
| | propylene oxide (ratio 75:25) and with an OH number of ca. 18 mg |
| | KOH/g |
| II | Polyether based on sorbitol and a mixture of ethylene oxide and |
| | propylene oxide (ratio 93.2:6.8) and an OH number of ca. 18 mg |
| | KOH/g |

DBTL: Dibutyltin Dilaurate

Production of the Polyurethanes According to the Invention

### Example 1

One-Pot Reaction

915 g (0.3 mole OH groups) of polyether I were weighed out under nitrogen in a 2 I capacity glass flask and freed from traces of water within 5 hours at 1 mbar/125° C. After cooling to 80° C., 14.26 g of 1-octanol (0.11 mole OH groups) and 22.1 g of 1-decanol (0.14 mole OH groups) were added and stirred for 15 minutes. 55.5 g of isophorone diisocyanate (0.50 mole isocyanate groups) and 0.09 g of DBTL were next added at 80° C. and then stirred at 80° C. until isocyanate bands could no longer be detected by IR spectroscopy. A highly viscous, pale yellowish polyurethane resin was obtained.

### Example 2

Two-Stage Process

915 g (0.3 mole of OH groups) of polyether I were weighed out under nitrogen in a 2 I capacity glass flask and freed within 5 hours from traces of water at 1 mbar/125° C. After cooling to 120° C., 1.11 g of isophorone diisocyanate were added (0.01 mole of isocyanate groups) and stirred at 120° C. until isocyanate bands could no longer be detected by IR spectroscopy. After cooling to 80° C., 14.26 g of 1-octanol (0.11 mole of OH groups) and 22.1 g of 1-decanol (0.14 mole of OH groups) were added and stirred for 15 minutes. Following this 54.39 g of isophorone diisocyanate (0.49 mole of isocyanate groups) and 0.09 g of DBTL were added at 80° C. and then stirred at 80° C. until isocyanate bands could no longer be detected by IR spectroscopy. A highly viscous, pale yellowish polyurethane resin was obtained.

The polyurethane thickeners listed in the following Table 1 were produced similarly to Example 1 and dissolved after completion of the reaction to form 60% solutions in water, Levalin FD (commercial product from Bayer AG) and Emulsifier WN (commercial product from Bayer AG) (ratio 3:2:1). In the case where monoisocyanates are used the polyether employed is first of all completely reacted with the monoisocyanate, and only then is the reaction with the alcohols and the diisocyanate carried out.

The polyurethane thickeners listed in the following Table 2 were produced similarly to Example 2 and after completion of the reaction were dissolved to form 60% solutions in water, Levalin FD and Emulsifier WN (ratio 3:2:1).

The specified gram-equivalents do not represent the gram-equivalent amounts actually employed, but represent the gram-equivalent ratio of the reactants that are used.

TABLE 1
Polyurethane thickeners according to Example 1

| | | Diiso- | | | |
|---|---|---|---|---|---|
| | Polyether | cyanate | Monoisocyanate | Monoalcohol | Cata- |
| Ex. # | (g.-eq.) | (g.-eq.) | (g.-eq.) | (g.-eq.) | lyst |
| 3 | I (3.0) | IPDI | — | 1-dodecanol (2.5) | DBTL |
| | | (5.0) | | | |
| 4 | I (3.0) | IPDI | — | 1-decanol (2.5) | DBTL |
| | | (5.0) | | | |
| 5 | I (3.0) | IPDI | — | 1-dodecanol (0.5) | DBTL |
| | | (5.0) | 1-decanol (2.0) | | |
| 6 | I (3.0) | IPDI | — | 1-decanol(1 .67) | DBTL |
| | | (5.0) | | 2-ethylhexanol | |
| | | | | (0.83) | |
| 7 | I (3.0) | IPDI | — | 1-decanol (1.25) | DBTL |
| | | (5.0) | | 1-octanol (1.25) | |
| 8 | I (3.0) | IPDI | — | 1-octanol (2.5) | DBTL |
| | | (5.0) | | | |
| 9 | I (3.0) | IPDI | stearyl isocyanate | 1-decanol (0.7) | DBTL |
| | | (2.5) | (1.25) | 1-octanol (0.55) | |
| 10 | II (6.0) | IPDI | stearyl isocyanate | 1-dodecanol (2.0) | DBTL |
| | | (3.5) | (2.0) | | |
| 11 | II (6.0) | IPDI | dodecyl | 1-octanol (1.0) | DBTL |
| | | (2.0) | isocyanate (3.0) | | |
| 12 | II (6.0) | IPDI | dodecyl | 1-decanol (1.0) | DBTL |
| | | (2.0) | isocyanate (4.0) | | |
| 13 | II (6.0) | IPDI | dodecyl | 1-dodecanol (2.0) | DBTL |
| | | (3.0) | isocyanate (3.0) | | |

TABLE 2
Polyurethane thickeners according to Example 2

| | Polyether | Diisocyanate | Monoalcohol | |
|---|---|---|---|---|
| Ex. # | (g.-eq.) | (g.-eq. 1/ g.-eq. 2) | (g.-eq.) | Catalyst |
| 14 | I (2.9) | IPDI (0.1/4.9) | 1-decanol (1.4) | DBTL |
| | | | 1-octanol (1.1) | |
| 15 | I (2.9) | IPDI (0.3/5.0) | 1-decanol (1.4) | DBTL |
| | | | 1-octanol (1.1) | |
| 16 | I (2.9) | IPDI (0.1/5.25) | 1-decanol (1.4) | DBTL |
| | | | 1-octanol (1.1) | |
| 17 | I (2.9) | IPDI (0.3/5.25) | 1-decanol (1.4) | DBTL |
| | | | 1-octanol (1.1) | |
| 18 | I (3.0) | IPDI (0.1/5.0) | 1-decanol (1.4) | DBTL |
| | | | 1-octanol (1.1) | |
| 19 | I (2.9) | IPDI (0.5/5.15) | 1-decanol (1.4) | DBTL |
| | | | 1-octanol (1.1) | |
| 20 | I (2.9) | IPDI (0.65/5.0) | 1-decanol (1.4) | DBTL |
| | | | 1-octanol (1.1) | |

### Comparison Example 1

1) Production of a Prepolymer from Isophorone Diisocyanate and 1-Dodecanol

1110 g of isophorone diisocyanate (10 gram-equivalents) were placed under a nitrogen atmosphere in a 2 I capacity three-necked flask equipped with stirrer, reflux cooler and dropping funnel and heated to 100° C. while stirring. 186 g (1 gram-equivalent) of 1-dodecanol were then added dropwise within 60 minutes. The mixture was then stirred for a further 2 hours at 100° C. Following this the resultant product was subjected to thin layer distillation (170° C., 0.25 mbar) and the excess isophorone diisocyanate was thereby completely removed. A colorless viscous resin with an isocyanate content of 10.8% was obtained.

2. Production of a Polyurethane Thickener Using a Prepolymer

The procedure of Example 3 was followed except that the polyether I was reacted with the aforedescribed prepolymer instead of with IPDI/dodecanol. A pale yellow resin was formed that was dissolved to form a 60% solution in water, Levalin FD® and Emulsifier WN® (3:2:1).

Examples of Use

The following examples show that emulsion paints having improved brushing properties (“brush resistance”) can be obtained with the thickening agents according to the invention.

Production of the coating compound and testing of the coating properties

The following constituents are dispersed over 30 minutes in a 1000 ml flask with 100 glass beads (Ø 3 mm) using a Skandex disperser:

| | |
|---|---|
| AMP (aminopropanol)¹⁾ | 1.25 g |
| Borchigen ND (25% in H₂O)²⁾ | 6.8 g |
| Neocryl AP 2860 (20%) defoaming agent³⁾ | 1.6 g |
| Thickener (50%) | 10.0 g |
| TiO₂ RHD-2 (Tioxide Company) | 112.5 g |
| Methoxybutanol | 8.5 g |
| Propylene glycol | 8.5 g |
| Butyl diglycol | 8.5 g |
| H₂O | 22.35 g |
| then after the addition of H₂O | 50.0 g |
| Neocryl XK 62 (42%)⁴⁾ | 270.0 g |
| | 500.0 g |

¹⁾(2-amino-2-methylpropanol-1, 90% in water), Angus Chemie GmbH, Essen
²⁾Wetting agent, Borchers GmbH, Monheim
³⁾Defoaming agent, ICI Resins, Runcorn, England
⁴⁾Anionic dispersion based on acrylate/styrene, ICI Resins

is dispersed for a further 30 minutes. The colorant is freed from the glass beads and after a maturation time of ca. 12 hours was coated onto a plastics film (Linetta film) using a brush. The quality of the coat (coating properties) are evaluated on a scale ranging from I (very good) to X (very poor) (“brush resistance” in Tables 3 to 5).

The viscosity measurements were made in the low-shear range at 10.3s⁻¹ using an Haake VT 500 viscosimeter (measurement body SV DIN), and in the high-shear range at 10000s⁻¹ using a Physika Rheolab viscosimeter.

TABLE 3
Application technology testing of the products of Table 1

| | Viscosity (mPa · s) at s⁻¹ | | Brushing |
|---|---|---|---|
| Example No. | 10.3 | 10000 | Properties |
| 3 | 7300 | 170 | IV-V |
| | 16500^{a)} | 200 | V |
| 4 | 2500 | 280 | III |
| 5 | 3900 | 170 | V |
| 6 | 1500 | 240 | III |
| 7 | 1600 | 260 | III |
| 8 | 400 | 160 | III-IV |
| 9 | 8500 | 200 | IV |
| 10 | 28000 | 150 | VI |
| 11 | 5800 | 170 | V |
| 12 | 6300 | 190 | IV |
| 13 | 27600 | 160 | VI |
| As comparison: | | | |
| Bermodol 2110^{b)} | 450 | 110 | VII |
| Acrysol 2020^{c)} | 350 | 100 | VII |
| Comp. Example 1 | 9200 | 130 | VII |

^{a)}Amount added 1.0% w.r.t. paint
^{b)}AKZO
^{c)}Rohm & Haas Co.

TABLE 4
Application technology testing of the products of Table 2

| | | |
|---|---|---|
| Thickener from | Viscosity (mPa · s) at s-1 | Brushing |

| Example No. | 10.3 | 10000 | Properties |
|---|---|---|---|
| 14 | 950 | 220 | III |
| 15 | 1500 | 200 | III |
| 16 | 1500 | 300 | III |
| 17 | 1700 | 300 | III |
| 18 | 900 | 240 | III-IV |
| 19 | 2100 | 260 | III-IV |
| 20 | 2500 | 280 | III-IV |
| As comparison: | | | |
| Bermodol 2110 | 450 | 110 | VII |
| Acrysol 2020 | 350 | 100 | VII |
| Comp. Example 1 | 9200 | 130 | VII |

Table 5 shows the use of the thickening agents according to the invention in combination with cellulose derivatives (Walocel XM 20000 PV; Borchers GmbH, Monheim)

TABLE 5
Application technology testing

| Product | Ratio PUR | Viscosity | | |
|---|---|---|---|---|
| from | Thickener/ Cellulose | (mPa · s) at s⁻¹ | | Brushing |
| Example No. | (wt. %, w.r.t. to paint) | 10.3 | 10000 | Properties |
| 16 | 0.25:0.25 | 3100 | 120 | VI |
| 16 | 0.25:0.40 | 7100 | 150 | V |
| 16 | 0.80:0.40 | 7400 | 210 | IV |
| 6 | 0.50:0.40 | 8300 | 200 | IV |
| 7 | 0.50:0.40 | 7500 | 190 | IV |
| Comparison | 0.50:0.40 | 7200 | 150 | VI |
| Bermodol 2110 | | | | |

Summary

From the test results given in Tables 3 to 5 it can clearly be seen that the polyurethane thickeners according to the invention have a better thickening effect in the high-shear range and generally have a better thickening effect in the low-shear range than the comparison products. The brushing properties of the paints with the polyurethane thickeners according to the invention are in all cases better than the brushing properties of the paints containing the comparison products.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A water-soluble or water-dispersible polyurethane comprising the reaction product of
A) at least one polyether polyol a1) having a average functionality of ≧3 and at least one urethane group-containing polyether polyol a2) having an average functionality of ≧4,
B) at least one monoalcohol with 6 to 22 carbon atoms,
C) at least one (cyclo)aliphatic and/or aromatic diisocyanate
D) optionally at least one monoisocyanate with 4 to 18 carbon atoms, and
E) optionally at least one polyisocyanate having an average functionality of >2,
wherein the starting NCO/OH equivalent ratio is between 0.5:1 to 1.2:1.

2. The polyurethane of claim 1 wherein polyether polyol a1) has an average functionality of 3 to 4.

3. The polyurethane of claim 1 wherein polyether polyol a1) has an average functionality of 4 to 6.

4. The polyurethane of claim 1 wherein monoalcohol B) has 6 to 18 carbon atoms.

5. The polyurethane of claim 1 wherein diisocyanate C) is a (cyclo)aliphatic diisocyanate.

6. The polyurethane of claim 1 wherein monoisocyanate D) has 8 to 18 carbon atoms.

7. The polyurethane of claim 1 obtained in a one-stage or multi-stage reaction.

8. The polyurethane of claim 1 wherein urethane group-containing polyether polyol a2) is produced by partial reaction of polyether polyol a1) with a diisocyanate.

9. The polyurethane of claim 8 wherein urethane group-containing polyether polyol a2) is produced by partial reaction of polyether polyol a1) with a polyisocyanate having an average functionality of ≧2.

10. A process for the production of the water-soluble or water-dispersible polyurethane of claim 1, comprising reacting
A) a mixture of at least one polyether polyol a1) having an average functionality of ≧3 and at least 1 urethane group-containing polyether polyol a2) having an average functionality of ≧4,
B) at least one monoalcohol with 6 to 22 carbon atoms,
C) at least one (cyclo)aliphatic and/or aromatic diisocyanate,
D) optionally at least one monoisocyanate with 4 to 18 carbon atoms, and
E) optionally at least one polyisocyanate having an average functionality of >2
at a starting NCO/OH equivalent ratio of 0.5:1 to 1.2:1.

11. A process for adjusting the flow properties of an aqueous paint system, adhesive and another aqueous formulation comprising adding the polyurethane of claim 1 to the aqueous paint system, adhesive and another aqueous formulation.

12. An aqueous paint system, adhesive and another aqueous formulation comprising the polyurethane of claim 1.
